(19) United States
(12) Patent Application Publication
(10) Pub. No.: US 2024/0164391 A1
(43) Pub. Date: May 23, 2024

(54) COMBINED MULTI-VISION AUTOMATED CUTTING SYSTEM

(71) Applicant: THAI UNION GROUP PUBLIC COMPANY LIMITED, Samutsakorn (TH)

(72) Inventor: Stefan Mairhofer, Samutsakorn (TH)

(21) Appl. No.: 18/057,035

(22) Filed: Nov. 18, 2022

(51) Int. Cl. A22C 17/00; B26D 5/00; B26D 7/06

(52) U.S. Cl. CPC A22C 17/0086; B26D 5/007; B26D 7/0625; B26D 2210/02

(57) ABSTRACT

A food processing system includes a structural frame with a conveyor that defines a processing path. The system includes a vision subsystem that captures images of opposite sides of a material on the conveyor and generates superimposed and extracted boundaries of main products and co-products in the material based on the images. The boundaries are converted into coordinates for guiding an automated cutting subsystem, which cuts the material along the boundaries. The separation and material handling subsystem utilizes curvature in the conveyor and a shaker conveyor system to separate or provide more space between the main products and the co-products after the cutting operation. The separation and material handling subsystem may also include a pick and place system that identifies and remove the co-products from the main products on the conveyor, while also providing feedback to the vision subsystem to improve the precision of additional cutting operations.

### BACKGROUND

### Technical Field

The present disclosure generally relates to vision-guided cutting systems that may be particularly advantageous in food processing, and more particularly, but not exclusively, to a combined multi-vision system and associated methods to guide an automated cutting system for separating main products and co-products from food materials that can highly vary in appearance.

### Description of the Related Art

Food processing has been known for many years, with one particular field within the broader industry being fish processing. Tuna is one of the world's leading fishery resources and may generally include a number of different species or subspecies of fish that each have different characteristics. However, tuna is a complex fish to process due to its unique characteristics relative to other fish, such that most automated processing technology is directed to processing fish with less complex geometries like white fish and salmon. As a result, tuna processing with conventional technologies remains an inefficient and expensive process.

Tuna may be initially received frozen as a whole fish. In a less conventional way of processing, the whole frozen tuna is butchered by cutting the frozen fish into “slices” vertically along the length of the fish with the skin, bones, dark meat, viscera, and other parts (collectively, “co-products”) intact along with white meat (“main product”) in the resulting frozen cross section cuts. The frozen cross section cuts are then subjected to additional processing techniques to separate the main product from co-products. In most traditional applications, the whole tuna is allowed to thaw before butchering, cleaning and further processing into fillets, which has become the most adopted way of processing tuna, despite major limitations and impracticalities throughout the operation. As a result, fewer methods have been developed for processing frozen cross section cuts to eliminate thawing from the process flow. Specifically, conventional technologies for processing frozen fish have a number of challenges.

For example, certain prior methods involve knife-based cutting systems that generally are insufficiently accurate to efficiently and precisely process complex shapes. These issues are further compounded when attempting to process fish of different sizes, shapes, and other characteristics, as in processing tuna cross section cuts. Most other technologies are for processing fish fillets instead of cross section cuts and are therefore ineffective in processing cross section cuts due to the differences between fillet processing and cross section cut processing. For example, processing of a fish fillet requires thawing and is generally performed in sequence, with the skin removed first, followed by the bones, then the dark meat, etc., until only the main product remains. Processing cross section cuts is more complex and difficult because the number of co-products for processing in each cross section cut is greater than the number of co-products in each sequence step (i.e., only one co-product at a time) in processing a fillet, and each co-product in the cross section cuts is smaller relative to the main product than in fillet processing. Thus, known technologies for processing fillets are not applicable and are not effective in processing cross section cuts.

Certain automated fish processing techniques have also been proposed, yet these techniques also have drawbacks. For example, known automated processing techniques have inadequate vision systems, which prevents the system from obtaining the information and details for successfully processing cross section cuts of meat. Known automated systems also do not have the ability and flexibility to accurately and precisely cut complex shapes and geometries that are encountered in the industry across different sizes, shapes, and types (i.e. species or subspecies) of fish. In general, conventional automated processing techniques are inadequate for processing of frozen cross section cuts of fish, and in particular frozen tuna cross sections.

As a result, it would be advantageous to have automated food processing techniques that overcome the disadvantages and drawbacks of known systems and methods.

### BRIEF SUMMARY

Generally speaking, automation in food processing benefits from intelligent and information-driven solutions. Given that most raw food materials are naturally sourced, each individual item therefore comes with a unique appearance in shape and composition. In order to grant a yield-efficient process, automated processing systems preferably are able to adapt to a range of varying material properties and conditions.

The concepts of the disclosure achieve such a yield-efficient process that is adaptable to varying material properties and conditions through a combination of multiple and different vision technologies that collectively extract material relevant information and an automated cutting system that acts on information from the vision system to precisely separate main products from co-products during processing. The concepts of the present disclosure broadly include vision technologies and computational methods that combine and extrapolate information, a conveyor system that facilitates the handling of material and acquisition of data, controlled material flow for coordination, and a flexible cutting system to achieve high precision.

In more detail, line-scan cameras of a vision subsystem image opposite surfaces of a material for processing, which may be a cross section cut of tuna in a non-limiting example. The cross section cut may be frozen or at least partially frozen and completely intact, meaning that the cross section cut includes viscera, skin, bones, and other co-products in addition to the more valuable white meat main product. As such, the vision subsystem may image the opposing flat and planar surfaces of the cross section cut of tuna. In some examples, the vision subsystem further includes an x-ray imaging system, infrared cameras, or other imaging devices to provide additional information.

The images may be captured at specific wavelengths of light, or may be analyzed or processed at specific wavelengths of light, to determine boundaries of different products on the opposing surfaces of the material or cross section cut. The information from the imaging sources can then be superimposed and interpolated to allow extraction of boundaries of the products through the material that are further converted to coordinates for guiding an automated cutting subsystem. The automated cutting subsystem acts on the coordinates to process or cut the material and separate main products from co-products.

The cut pieces of the material are then provided to a separation and material handling subsystem that assists with separating the cut pieces and may include a pick and place system for identifying and removing co-products, while main products remain in the system for further processing. The pick and place system may be associated with an additional vision system for identifying the main products and co-products, and also for providing a feedback loop. For example, the vision system associated with the pick and place system may identify that the actual results of cutting vary from the expected results of cutting (i.e., the final products include additional impurities, all of the co-products were not accurately removed, etc.) relative to the expected results of cutting from the extracted boundaries. If the variance in the finished products relative to the expected products exceeds a selected threshold, the vision system associated with the pick and place system instructs the vision subsystem and/or the automated cutting system to adjust the superimposed and extracted boundaries and/or the cutting path, respectively, to eliminate the variance.

Other features and advantages of the present disclosure are provided below.

### BRIEF DESCRIPTION OF THE SEVERAL VIEWS OF THE DRAWINGS

The present disclosure will be more fully understood by reference to the following figures, where like labels refer to like parts throughout, except as otherwise specified. The figures do not describe every aspect of the teachings disclosed herein and do not limit the scope of the claims.

FIG. 1 is an elevational view of a cross section cut of a tuna according to embodiments of the present disclosure.

FIG. 2 is a cross-sectional view of a lengthwise cut of a tuna according to embodiments of the present disclosure.

FIG. 3 is an isometric view of a combined multi-vision automated cutting system according to embodiments of the present disclosure.

FIG. 4A is an isometric view of a vision subsystem of the combined multi-vision automated cutting system of FIG. 3.

FIG. 4B is a detail view of a conveyor component of the vision subsystem of FIG. 4A.

FIG. 4C is a schematic detail view of a nosebar of the conveyor component of FIG. 4B.

FIG. 5 is a schematic illustration of superimposed and extracted boundaries from the vision subsystem to guide an automated cutting subsystem of the combined multi-vision automated cutting system of FIG. 3.

FIGS. 6A-6C are graphical representations illustrating a contrast in intensity of light between different parts of a tuna at different wavelengths of light according to embodiments of the present disclosure.

FIG. 6D is a series of images illustrating a cross section cut of a tuna at different peak contrast wavelengths to highlight areas of interest for processing according to embodiments of the present disclosure.

FIG. 7 is an isometric view of the automated cutting subsystem of the combined multi-vision automated cutting system of FIG. 3.

FIG. 8 is an isometric view of a material handling and separation subsystem of the combined multi-vision automated cutting system of FIG. 3.

FIG. 9 is an isometric view of a divergent conveyor system for parallel cutting operations according to embodiments of the present disclosure.

### DETAILED DESCRIPTION

Persons of ordinary skill in the relevant art will understand that the present disclosure is illustrative only and not in any way limiting. Other embodiments of the presently disclosed systems and methods readily suggest themselves to such skilled persons having the assistance of this disclosure.

Each of the features and teachings disclosed herein can be utilized separately or in conjunction with other features and teachings to provide automated cutting systems devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are exactly to scale and intended to limit the dimensions and the shapes of the components.

Although representative embodiments will be described below in the context of processing frozen tuna fish, and in particular, frozen cross section cuts of tuna, it is to be appreciated that the concepts of the disclosure can be applied to any food processing technology and is not limited solely to processing frozen tuna. For example, the concepts of the disclosure are applicable at least to other food materials of planar cross-sections, be it in frozen, in thawed, or in cooked state. Further, the concepts of the disclosure can be applied to any processing operation that benefits from adaptive and complex cutting patterns for separation of different parts or portions, including, but not limited to, the processing of steaks in the meat industry, or for fruits and vegetables that are packed in thick slices for the consumer, among others.

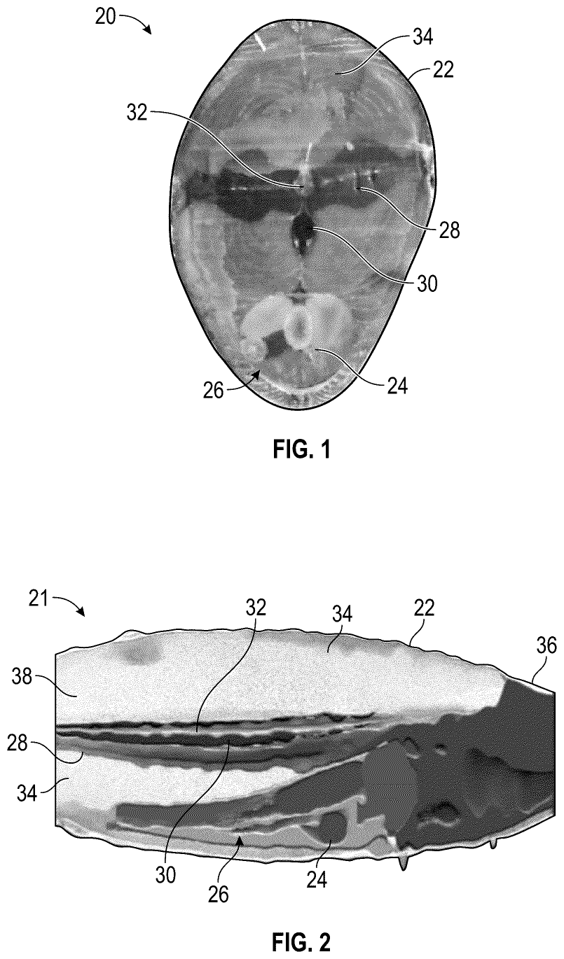

FIG. 1 shows a cross section cut 20 of tuna. As noted above, tuna is typically frozen whole and butchered to produce frozen cross section cuts, such as cross section cut 20, for further processing. The frozen cross section cuts 20 arrive at a processing facility in cross section cuts or slices of predetermined thickness that are completely frozen or at least partially frozen. The image of the cross section cut 20 in FIG. 1 is a representative example of such a cross section cut typical in the industry, which may be formed by slicing the tuna vertically in predetermined intervals along the length of the tuna to yield cross section cuts of a selected thickness. After the frozen tuna is initially butchered into cross section cuts 20, the cuts 20 are sent to a food processing facility for separation of main products from co-products, while also removing impurities. Importantly, the cuts 20 typically arrive at a processing facility completely intact, meaning that viscera and other less desirable products remain in the cuts 20.

For example, the cross section cut 20 in FIG. 1 includes the skin 22, viscera 24 in a gut cavity 26, dark meat 28, blood clots 30, bones 32, and white meat 34, along with other impurities and co-products that are not illustrated. Each of these features can vary in size, shape, and location, among other characteristics, for each cross section cut 20 according to the characteristics of the fish as well as the location of the cross section cut 20. In a non-limiting example, a cross section cut 20 closer to the head of a fish may include the viscera 24, while a cross section cut 20 closer to the tail may not include viscera 24. In a further non-limiting example, each of the above-referenced features, namely, the skin 22, viscera 24, gut cavity 26, dark meat 28, blood clots 30, bones 32, and white meat 34 will generally be larger or smaller in each cross section cut 20 depending on the characteristics of the originating fish as well as the location of the cross section cut 20 in one particular fish.

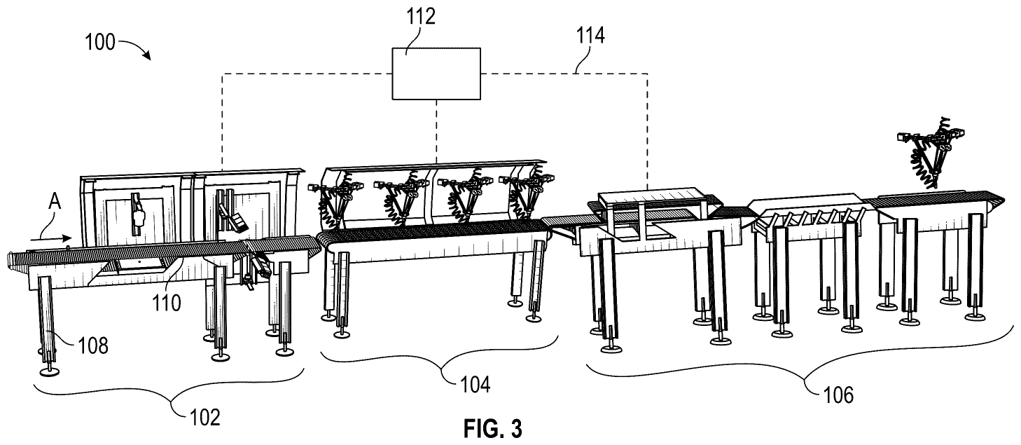

FIG. 2 is a lengthwise cross-sectional view of a tuna 21 illustrating the variation in the above characteristics of the tuna 21 along its length. As shown in FIG. 2, each of the skin 22, viscera 24, gut cavity 26, dark meat 28, blood clots 30, bones 32, and white meat 34 change in size, shape, and location, among other characteristics, along the length of the tuna 21 from a head 36 toward a tail end 38 of the tuna 21. Generally, the white meat 34 is more desirable than other co-products such as skin 22, viscera 24, dark meat 28, blood clots 30, bones 32, and other impurities. Due to the unique shape and features of each cross section cut 20 (FIG. 1) of a tuna 21, prior processing techniques have been not able to process cross section cuts 20 (FIG. 1) accurately, precisely, and efficiently. In particular, materials of given characteristics are very complex for manual processing, due to the number of composing parts, their sizes and shapes, accessibility to perform the necessary cuts and the throughput at which they are handled to produce desirable yields. For the same reasons, it is a substantial challenge for any automated system to process such material effectively and with a precision expected in the industry. As will be described in more detail below, the concepts of the disclosure describe a processing or cutting system that is capable of separating the desirable white meat 34 from the other various co-products, including, skin 22, viscera 24, dark meat 28, blood clots 30, bones 32, and impurities while also overcoming the deficiencies and disadvantages of known systems.

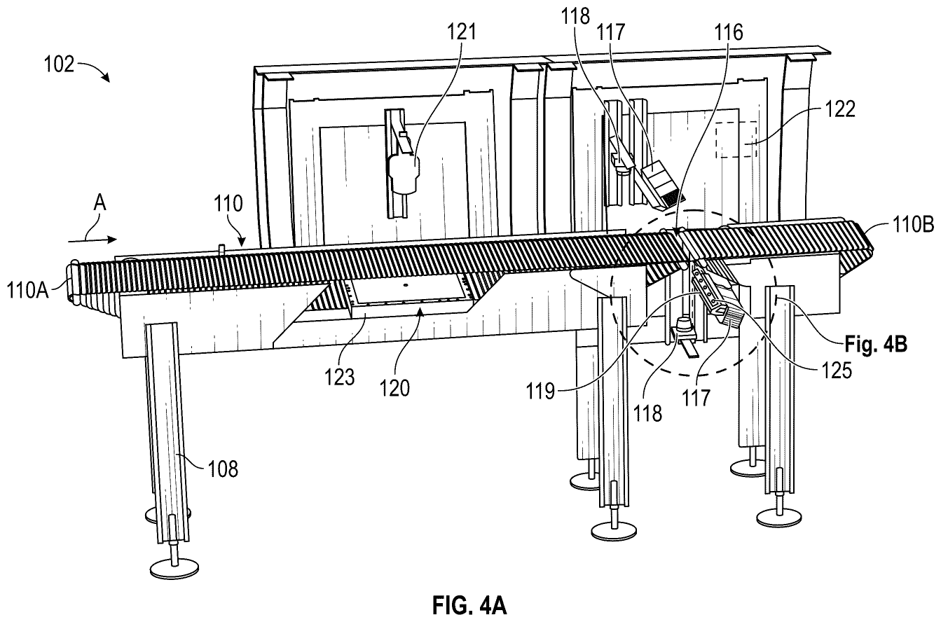

FIG. 3 is an isometric view of a combined multi-vision automated cutting system 100 (which may also be referred to herein as a cutting system 100, processing system 100, or as simply a system 100). The system 100 includes three primary subsystems that will be explained in more detail below, namely a vision subsystem 102, an automated cutting subsystem 104, and a material handling and separation subsystem 106. As shown in FIG. 3, each of the subsystems 102, 104, 106 are arranged in sequential order along a processing path generally indicated by arrow A (i.e., left to right in the orientation of FIG. 3). Further, the subsystems 102, 104, 106 are associated with a structural frame 108 for supporting the subsystems 102, 104, 106 with each subsystem 102, 104, 106 aligned with the other subsystems 102, 104, 106 and each including a respective conveyor 110 for moving material along the processing path A. The conveyor 110 of each subsystem 102, 104, 106 may be associated with a corresponding drive assembly including a motor, wheels, gears, chains, pulleys, belts, nosebars, and the like for driving the respective conveyor 110. Alternatively, a single drive assembly may be utilized to drive all of the conveyors 110. As such, material, for example, cross section cuts 20 of tuna, can be loaded onto the conveyor 110 and conveyed past the vision subsystem 20 first, followed by the automated cutting subsystem 104, and finally the material handling and separation subsystem 106 along the processing path A. At least some, or all, of the subsystems 102, 104, 106 may also be in communication, either wired or wirelessly, with a controller 112, as indicated by dashed lines 114 that is capable of executing at least some of the functions and techniques described herein.

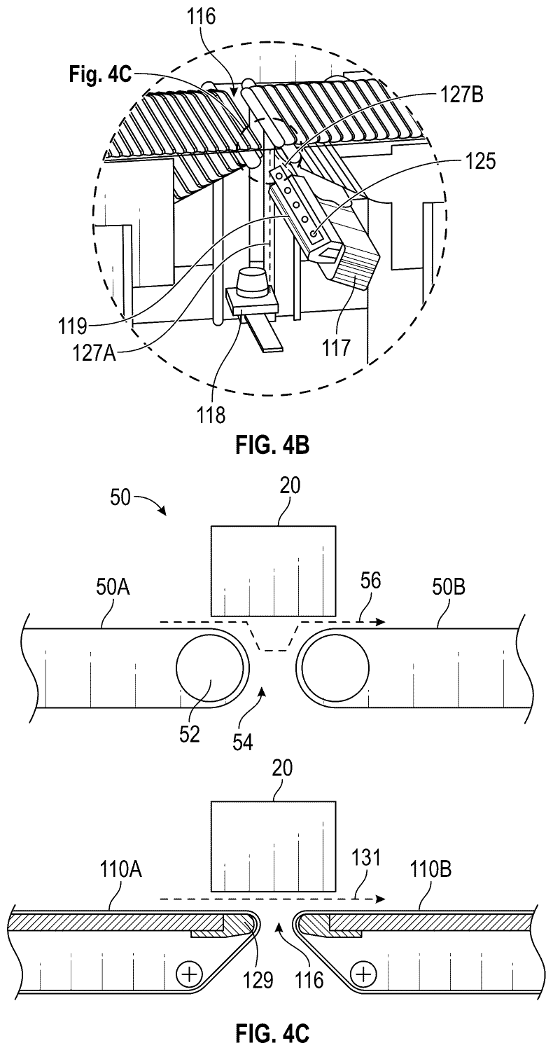

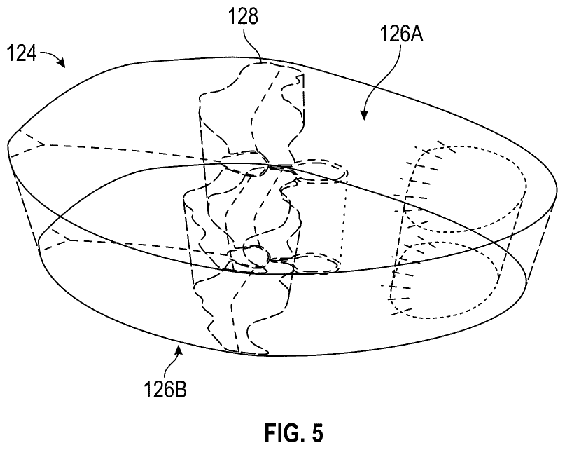

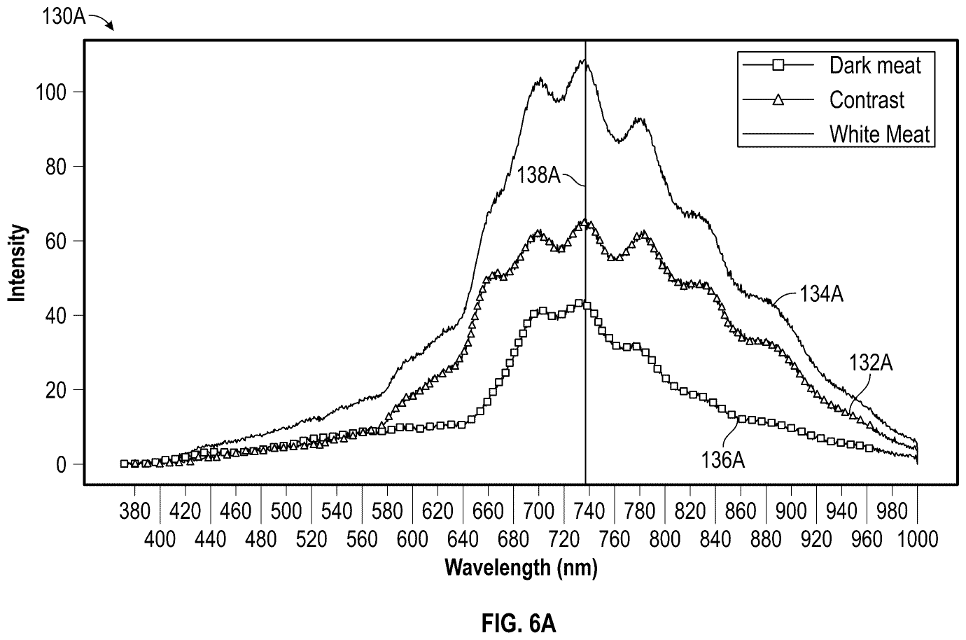

FIG. 4A provides additional detail of the vision subsystem 102 of the combined multi-vision automated cutting system shown in FIG. 3. The vision subsystem 102 includes the structural frame 108 and the conveyor 110 configured to convey material, such as cross section cuts 20 (FIG. 1) along the processing path A. In an embodiment, the conveyor 110 includes two separate and distinct conveyor components 110A, 110B that are separated by a space or air gap 116 to allow for imaging of two opposite sides (i.e., above and below or top and bottom sides in some non-limiting examples) of the material on the conveyor portions 110A, 110B through the air gap 116. The vision subsystem 102 includes at least two line-scan cameras 118 and may optionally include an x-ray system 120 and one or more infrared cameras 122. The line-scan cameras 118 are positioned opposite each other relative to the conveyor 110 (i.e., one camera 118 on one side or above the conveyor 110 and the other camera 118 on the opposite side or below the conveyor 110) to capture two surfaces of the cross section cuts 20 (FIG. 1), or other material, as noted above. Each line-scan camera 118 is associated with a respective line-light 117 (which may also be referred to as a light source 117). Further, the line-scan cameras 118 may be mounted on a support structure that enables sliding of the cameras 118 to adjust a position of the cameras 118 relative to a width direction (i.e. into and out of the page in the orientation of FIG. 4A) of the conveyor components 110A, 110B to assist with calibration and alignment of the vision subsystem 102. In the following disclosure, the combination of the cameras 118 and the light sources 117 will be referred to as line-scan cameras 118, except as otherwise noted. The x-ray system 120 and one or more infrared cameras 122 may be arranged upstream or downstream of the line-scan cameras 118, or may be arranged at (i.e., in alignment with or proximate to) the line-scan cameras 118 in some embodiments. The x-ray system 120 may include an x-ray source 121 and a detector 123, with the source 121 positioned above, and the detector 123 positioned below, the first portion 110A of the conveyor component 110. The x-ray system 120 may also be located upstream of the line-scan cameras 118 in some embodiments with the source 121 arranged above the first conveyor portion 110A to allow an unobstructed transmission of x-rays through of objections on the first conveyor portion 110A to the detector 123. The one or more infrared cameras 122 are illustrated schematically with dashed lines due to the optional nature of these components and the selectivity in arrangement of the same in the vision subsystem 102.

At least the line-scan camera 118 below the conveyor components 110A, 110B is arranged with a field of view through, or least partially through, the air gap 116. The x-ray system 120 is for capturing objects inside the material, or cross section cuts 20 (FIG. 1), which can be beneficial to the processing operation, but is optional depending on the particular application. Likewise, the one or more infrared cameras 122 allow additional information to be captured for completeness and in some examples, improved accuracy and precision, although the concepts of the disclosure are sufficiently accurate and precise for advantageous yields without the x-ray system 120 and/or the one or more infrared cameras 122. In a preferred embodiment, the system 100 includes only the line-scan cameras 118 and x-ray system 120, as the additional information and precision gained from data acquired by the x-ray system 120 is beneficial for processing tuna cross section cuts 20 (FIG. 1), while the one or more infrared cameras 122 are omitted to reduce cost. In some embodiments, the vision subsystem 102 can be extended by including other imaging or measurement devices if considered relevant to the operation. As such, the particular configuration of the vision subsystem 102 illustrated in FIG. 4A is non-limiting. In general, the selection of components for the vision subsystem 102 is based on the particular application and processing of different materials, such that the disclosure is not limited solely to the examples provided herein.

The incident light and pixel-wide exposure of the sensors or cameras 118 is preferably directed onto the same spot of the passing object or cross section cuts 20 (FIG. 1) to improve imaging accuracy. As a result, the gap 116 between the conveyor components 110A, 110B is preferably sized and shape to permit a particular angle of intersection between the incident light and pixel-wide exposure of the sensor or cameras 118 as best shown in FIG. 4B. Where the gap 116 is very narrow (i.e., less than 3 mm), a coaxial light 119 that illuminates the object parallel to the optical axis can be integrated in the vision subsystem 102. The coaxial light 119 is particularly advantageous to the camera 118 (or imaging system) positioned below the conveyor components 110A, 110B to capture the surface of the object or cross section cuts 20 (FIG. 1) from below the object in some embodiments. The camera 118 (or imaging system) that is positioned above the conveyor components 110A, 110B to capture images of the upper surface of the object or cross section cuts 20 (FIG. 1) may omit a coaxial light, or may not otherwise benefit from a coaxial light in some embodiments. In a preferred embodiment, the two imaging systems or cameras 118 are not mounted directly opposite to each other (i.e., are not aligned with each other along a vertical axis through a center of each camera 118) to avoid interference of light from one camera 118 to the other. Instead, the cameras 118 are preferably offset from each other by at least a few millimeters, such as between 1 mm to 10 mm or more preferably between 1 mm to 5 mm. In this context only, “offset” means that a first vertical axis passing through a center of one camera 118 is not coaxial with a second vertical axis passing through a center of the other camera 118, but rather, the first vertical axis is spaced from the second vertical axis.

The camera 118 that is positioned below the opening gap 116 may be protected from spillage or debris that might fall through the gap 116 by air nozzles 125 that divert the trajectory of the debris in some embodiments. The air nozzles 125 may be mounted on a bar and/or one or more air tubes coupled to the structural frame 108 and structured to continuously output air during operation such that any material or debris that falls through the gap 116 is directed away from the line-scan camera 118 below the gap 116. The nozzles 125 may be arranged in series in a single row with equidistant spacing, or in some other arrangement, including more than one row and irregular spacing according to the particular application. The two imaging devices or cameras 118 may be a preferable arrangement for a minimal composition for the vision subsystem 102, although the intended application of processing tuna cross section cuts 20 (FIG. 1) may benefit from the x-ray imaging system 120 that provides additional complementary information to the composition of images from the cameras 118. As noted above, the x-ray imaging component 120 can either precede or follow the line-scan imaging devices 118, meaning that the x-ray imaging component 120 can be upstream or downstream of the cameras 118 and the gap 116.

FIG. 4B is a detail view of a portion of the conveyor component 110 of the vision subsystem 102 providing additional detail of the air nozzles 125 and the angle of intersection of the line of sight of the camera or image sensor 118 and the light source 117. In particular, the camera 118 may be positioned directly below the gap 116 and the light source 117 and/or coaxial light source 119 may be positioned offset from the camera 118. The camera 118 has a line of sight or field of view indicated by dashed line 127A and the light source 117 and/or coaxial light source 119 output light along dashed line 127B. As shown in FIG. 4B, the field of view 127A of the camera 118 and the light 127B output by the light source 117 and/or coaxial light source 119 are configured to intersect at the gap 116 for imaging of the cross section cuts (FIG. 1). The angle between dashed lines 127A, 127B may be any angle between 15 and 60 degrees or more or less in some embodiments, including all intervening and limit values. In some embodiments, the camera 118 may be positioned directly below the gap 116 with the light source 117 and/or coaxial light source 119 positioned at an angle to the gap 116, as above. As shown in FIG. 4A, the line-scan camera 118 above the conveyor component 110 may have a different arrangement and may generally be offset and upstream from the line-scan camera 118 below the gap 116 given that the line-scan camera 118 above the gap 116 images a top surface of the cross section cuts 20 (FIG. 1) and thus does not necessarily need to have a field of view through the gap 116. Further, the line-scan camera 118 above the conveyor component 110 may be offset from the line-scan camera 118 below the gap 116 to avoid interference of light from one camera 118 to the other. In some embodiments, both line-scan cameras 118 have a field of view through the gap 116, while in further embodiments, only the line-scan camera 118 below the gap 116 has a field of view through the gap 116 to enable unobstructed imaging of the bottom surface of the cross section cuts 20 (FIG. 1).

FIG. 4C is a schematic detail view comparing a conventional conveyor system 50 to the conveyor components 110A, 110B of the disclosure. In particular, the top image of FIG. 4C is a view of the conventional conveyor system 50, while the bottom image of FIG. 4C illustrates the conveyors 110A, 110B of the present disclosure. In a typical conveyor 50 shown in the top image, the conveyor 50 includes a roller 52 at the end of each conveyor component 50A, 50B that may have a diameter of around 3 centimeters. As such, when two conveyors 50A, 50B are arranged with a gap 54 therebetween, the radius of curvature of the rollers 50 of the separate conveyor portions 50A, 50B will draw an object 20 down before the next roller 50 and conveyor 50B engages the object 20 on the other side of the gap 54, as illustrated schematically by dashed line 56. In other words, conventional conveyors 50 have a large rounding edge associated with the relatively large diameter of the rollers 50. Such an arrangement can cause the object 20 to “jump,” be caught in the gap 54, or otherwise move on the conveyors 50A, 50B at the air gap 54. Movement of the object 20 changes the position of object 20 on the conveyors 50A, 50B relative to the calibration of a vision subsystem and can distort the determined boundaries of areas of interest, as described herein, leading to a less accurate and precise cutting operation.

As such, the conveyor components 110A, 110B of the disclosure are arranged to facilitate a smooth transition of materials across the air gap 116, while allowing the imaging of objects from both sides. In some embodiments, the conveyor components 110A, 110B are nosebar or knife-edge conveyors arranged in sequence and equipped with a nosebar (or knife-edge) 129 with a diameter or radius of curvature being only a few millimeters (“mm”) on each side of the air gap 116. In some non-limiting examples, the nosebar 129 may have a diameter or radius of curvature that is 1 mm or less, 2 mm, 3 mm, 4 mm, 5 mm, 6 mm, 7 mm, 8 mm, 9 mm, and/or 10 mm on each side. Such an arrangement forms a gap 116 large enough for a line-light and a line-scan camera, such as cameras 118 or others, to capture image data, while being sufficiently narrow to allow objects as small as one centimeter to traverse the conveyor components 110A, 110B without major disruption or alteration in position. The size of the gap 116 may therefore be any of the dimensions described above, namely 1 mm or less, 2 mm, 3 mm, 4 mm, 5 mm, 6 mm, 7 mm, 8 mm, 9 mm, and/or 10 mm in some embodiments. Other variations are possible, although a smaller gap is preferred to avoid a major disruption or alteration in position of materials as they traverse the conveyor components 110A, 110B, as above. In particular, the rounding edge of the conveyors 110A, 110B is considerably smaller than in conventional conveyor 50 because the nosebar 129 has a smaller radius of curvature than the rollers 52 of the conventional conveyor 50. As such, the arrangement of the conveyors 110A, 110B of the present disclosure enables the object 20 to traverse the gap 116 without a change in position or to proceed along a straight line (approximately horizontal), as indicated by dashed line 131 in the lower image of FIG. 4C, which increases accuracy and precision and avoids alignment or calibration issues attributable to movement of the object 20 on the conveyors 110A, 110B.

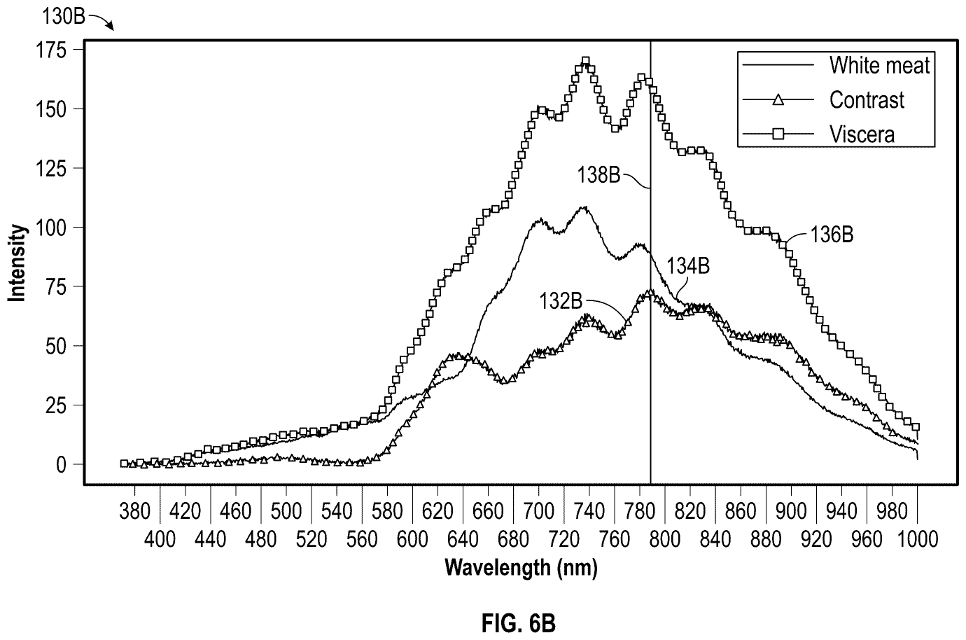

FIG. 5 is a schematic illustration of superimposed and extracted boundaries of the cross section cut 20 (FIG. 1) from the vision subsystem 102 that are used to guide the automated cutting subsystem 104 described in more detail below. The superimposed and extracted boundaries shown in FIG. 5 are indicated as reference 124 to clarify that the extrapolated boundaries are different from the physical cross section cut 20 shown in FIG. 1. In most processing applications of food materials, it is less preferable to perform non-invasive volumetric imaging because the volumetric imaging process is a slower, less efficient process that decreases throughput and capability to process large quantities. As a result, the concepts of the disclosure extrapolate as much information that can be practically captured around the surfaces of the cross section cuts 20 or other food materials and interpolate and/or extrapolate any missing information through calculations and model-based approximations. In operation, the cross section cuts 20 (FIG. 1) are conveyed along the conveyor components 110A, 110B (FIG. 4A) and the cameras 118 (FIG. 4A) scan or capture images of the top and bottom planar surfaces of the cross section cuts 20 indicated as 126A, 126B in FIG. 5 as the cuts 20 (FIG. 1) move past the air gap 116 (FIG. 4A).

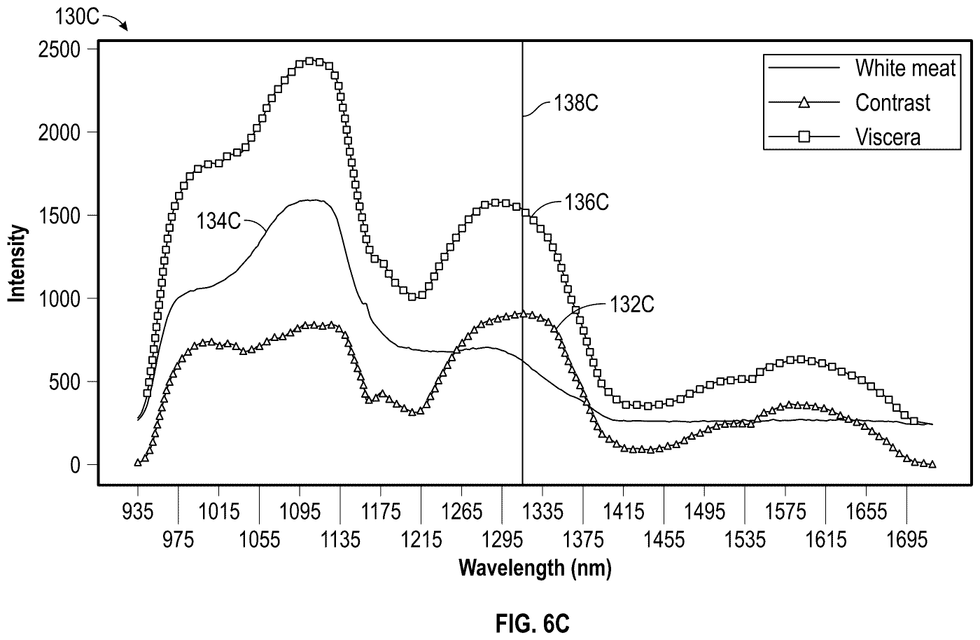

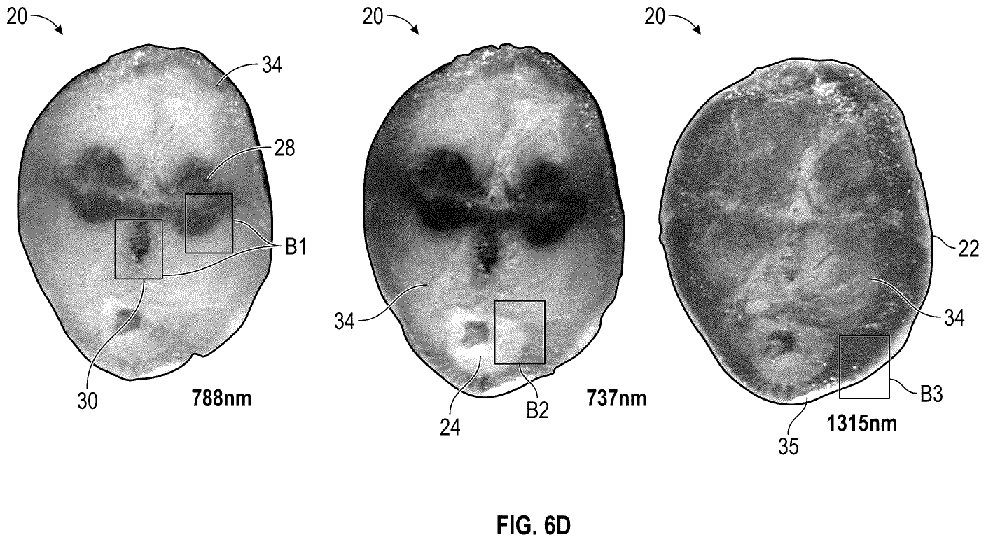

As will be explained in more detail with reference to FIGS. 6A-6D, the images captured by the cameras 118 can be utilized to determine boundaries of different components of the cross section cuts 20 (FIG. 1), such as via controller 112. When the boundaries of the components on the two opposite surfaces of the cross section cuts 20 (FIG. 1) are known, an approximation of the boundaries of each component through the cross section cuts 20 (i.e., between the two opposite surfaces) can be approximated by fitting lines through the cross section cuts (FIG. 1) that align with the identified components on the surfaces. In other words, the boundaries of the different components (i.e., dark meat 28, viscera 24, etc.) of the cross section cuts 20 are extracted from the images captured by the cameras 118 (FIG. 4A) and interpolated between the two opposite surfaces of the cuts 20 (FIG. 1) to generate an accurate approximation of the location of each component through the entire cross section cut 20 (FIG. 1), including changes in shape or position. An illustration of such an approximation is shown in FIG. 5, where all data is superimposed to form a single source of reference to be analyzed and from which information is extracted for automated guidance of the automated cutting subsystem 104. As a non-limiting example, FIG. 5 illustrates boundary lines 128 associated with dark meat 28 (FIG. 1) on both planar surfaces 126A, 126B as well as through the cross section cut 20 (FIG. 1), or between the planar surfaces 126A, 126B, based on information corresponding to the location of the dark meat 28 on the planar surfaces 126A, 126B.

FIGS. 6A-6C are graphical representations illustrating a contrast in intensity of light between different parts of a tuna at different wavelengths of light. FIG. 6D is a series of images illustrating a cross section cut of a tuna at different peak contrast wavelengths to highlight areas of interest based on the concepts of FIGS. 6A-6C. Beginning with FIGS. 6A-6C with continuing reference to FIG. 1, image contrast resolution allows for the distinction of differences in captured light intensities, which depending on the application, is particularly advantageous for the efficiency of the system and the capability of extracting sought information. In order to maximize detectability and identification of areas of interest in a material, wavelength specific illumination is applied. For identification and separation of white meat 34, dark meat 28, and blood clots 30, images can be captured at 737 nanometers (“nm”) wavelengths of light, or approximately 737 nm (i.e., between 727 to 747 nm). For identification and separation of white meat 34 and viscera 24, images can be captured at 788 nm wavelengths of light, or approximately 788 nm (i.e., between 778 to 798 nm). For identification and separation of white meat 34 and skin 22, images can be captured at 1315 nanometers (“nm”) wavelengths of light, or approximately 1315 nm (i.e., between 1305 to 1325 nm). It may be possible to identify and separate bones 32 from the remaining features of the cross section cuts 20 utilizing light at a particular wavelength, although identification of bones 32 may particularly benefit from x-ray imaging with x-ray system 120 (FIG. 4A) using both dual-energy x rays and low-energy x rays. Alternatively, the images may all be captured at the same wavelength of light and image contrast resolution at the indicated wavelengths above can be utilized for the distinction of differences in captured light intensities.

For the visible light spectrum, a high-frequency pulsing light is preferred to generate an alternating interlaced line pattern that allows two different images at different wavelengths to be captured with the same line-scan camera, such as camera 118 (FIG. 4A). Additional options include the use of a white-light illumination at continuous exposure with multiple cameras to which band-pass filters are applied for selective wavelength data. In one configuration, and due to the vicinity of the two peaks for high contrast, a red-light illumination with a sufficiently wide spread in the range of intensity spectrum can be utilized to cover both wavelengths near 737 nm and 788 nm. Such a configuration may have particular benefits with respect to cost and reduction of complexity in the imaging subsystem 102 (FIG. 4A).

The results of the above image capturing and/or processing techniques are shown in graphical form in FIGS. 6A-6C and in photograph form in FIG. 6D. In particular, FIGS. 6A-6C represent the contrast in light intensity between features of interest at different wavelengths of light to identify the peak contrast between features at different wavelengths of light. The peak contrast generally corresponds to a preferable wavelength of light to utilize for identification of different materials. Except as other noted, each of the graphs in FIGS. 6A-6C include the wavelength of light on the x-axis or horizontal axis and intensity of light on the y-axis or vertical axis. Beginning with FIG. 6A, illustrated therein is a first graph 130A providing a contrast 132A between frozen white meat 134A and frozen dark meat 136A. The peak contrast in FIG. 6A is indicated by line 138A, with the peak contrast 138A between the white meat 134A and dark meat 136A occurring at a wavelength of light of 737 nm, or around 737 nm. In an embodiment, the peak contrast 138A occurs specifically at 737.51 nm.

FIG. 6B provides a second graph 130B illustrating a contrast 132B between frozen white meat 134B and viscera 136B. The peak contrast in FIG. 6B is indicated by line 138B, with the peak contrast 138B between the white meat 134B and viscera 136B occurring at a wavelength of light of 788 nm, or around 788 nm. In an embodiment, the peak contrast 138B occurs specifically at 788.39 nm. FIG. 6C provides a third graph 130C illustrating a contrast 132C between frozen white meat 134C and a skit and fat layer 136C. The peak contrast in FIG. 6C is indicated by line 138C, with the peak contrast 138C between the white meat 134C and the skin and fat layer 136C occurring at a wavelength of light of 1315 nm, or around 1315 nm. In an embodiment, the peak contrast 138C occurs specifically at 1315.62 nm.

FIG. 6D provides a series of three images of a cross section cut 20 that correspond to the graphical representations in FIGS. 6A-6C and provide a visual representation of the peak contrast wavelengths. In other words, the image at left in FIG. 6D corresponds to FIG. 6A, the middle image in FIG. 6D corresponds to FIG. 6B, and the right image in FIG. 6D corresponds to FIG. 6C. Thus, from left to right, FIG. 6D illustrates images of the cross section cut 20 at 737 nm, 788 nm, and 1315 nm. Beginning with the left image in FIG. 6D with continuing reference to FIG. 1, illustrated therein is the cross section cut 20 at the peak contrast wavelength of 737 nm and boxes B1 highlighting the contrast between white meat 34, dark meat 28, and blood clots 30. The middle image in FIG. 6D illustrates the cross section cut 20 at the peak contrast of 788 nm and box B2 highlighting the contrast between white meat 34 and viscera 24. The right image in FIG. 6D illustrates the cross section cut 20 at the peak contrast of 1315 nm and box B3 highlighting the contrast between white meat 34, skin 22, and a fat layer 35 between the skin 22 and white meat 34. As a result, FIG. 6D illustrates that at selected wavelengths of light, boundaries between areas of interest, such as the boundary between white meat 34 and co-products, can be more clearly identified for further processing. In addition, the concepts of FIG. 6D can be applied to cross section cuts of different shapes, sizes, and other characteristics, as the identification of the boundaries is independent and unique for each cross section cut 20, while also being faster than typical volumetric imaging techniques.

The images acquired and interpolated by the vision subsystem 102, in some cases with assistance from controller 112 (FIG. 3) are utilized to guide the automated cutting subsystem 104 (FIG. 3). Given the integration of multiple imaging devices in the imaging subsystem 102, such as cameras 118 and others, all systems are preferably calibrated to share the same coordinate system. Referring back to FIG. 4A, alignment across the conveyor 110 in the vision subsystem 102 may be achieved through a one-time calibration using a visual reference object. Longitudinal synchronization can be achieved using an encoder and the timing of a signal from an optical laser trigger. Data acquired form the various imaging devices, such as at least cameras 118, are corrected for distortions particular to the device, so that image data can be superimposed for augmented information.

Computational methods and machine learning models are deployed to extract information from the superimposed image data, including boundary information of different compositions of the material using semantic model-based segmentation and extraction of key features relevant for the application. Traceable outlines are derived from the processed information using an algorithm that finds sets of pairwise correspondences from the equinumerous points interpolated from the boundaries of each object above and below the object's surface, thus forming a sequence of extrapolated angled trajectories to be followed as cutting paths. The sequences of coordinates and angles are transformed from the image space (Ix, Iy) into world coordinates (Wx, Wy, Wz) and then further into robotic coordinates (Rx, Ry, Rz, Rq1, Rq2, Rq3, Rq4) for automating the cutting operation, as described further below.

Since the expected application for the developed system is the cutting of planar objects, the concepts of the disclosure preferably omit three-dimensional and stereo vision cameras. The world coordinates can be calculated from the presumed or specified height of the material which is used as an intersection plane in the imaging space. The boundary information between material compositions informs, or assists in deriving, the cutting path, but they are not necessarily equivalent. The cutting path does have an initiation and termination point, and may follow a trajectory that is offset a certain distance from the determined boundary to correct or improve the precision of the cut, as explained in more detail below. In some embodiments, at least some, or all, of the above techniques are performed by the controller 112 (FIG. 3). Additional details of the controller 112 can be found in U.S. Provisional Patent Application No. 62/765,113 filed on Aug. 16, 2018 and International Application No. PCT/US2018/066314 filed on Dec. 18, 2018, both of which are incorporated herein by reference, in their entirety.

In sum, the controller 112 may have a memory configured to store instructions and at least one processor configured to execute the instructions to perform the above techniques, including but not limited to, activating the cameras 118 (FIG. 4A), acquiring image data from the cameras 118 (FIG. 4A), superimposing the image data and extracting information from the superimposed image data, generating boundary information based on the superimposed image data and associated computational methods and machine learning models, generating traceable outlines based on pairwise correspondences, forming a sequence of extrapolated angled trajectories, converting the coordinates and angles from image space into world coordinates and from world coordinates into robotic coordinates, and instructing the automating cutting subsystem 104 to perform a cut based on the robotic coordinates, among others.

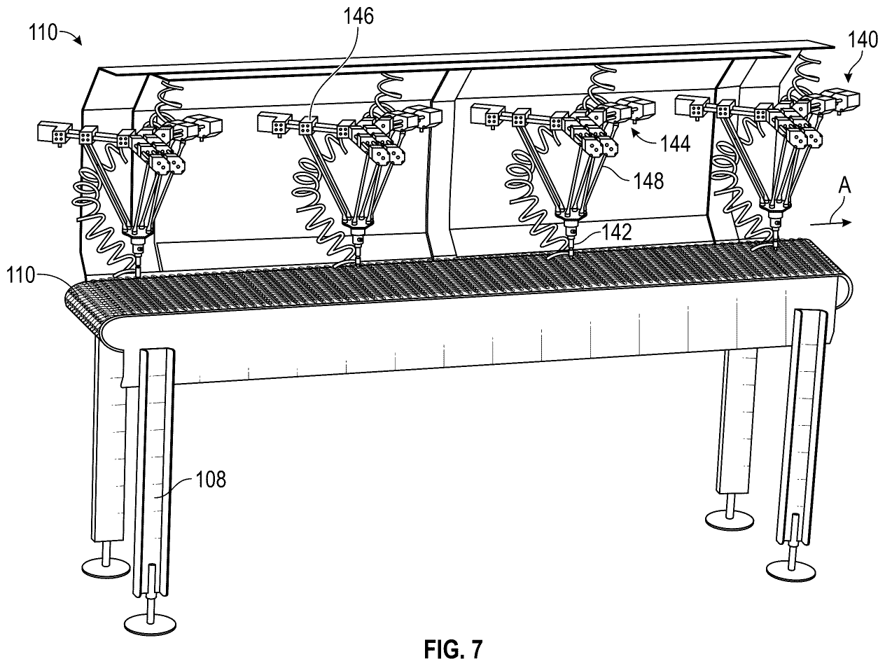

FIG. 7 provides additional detail of the cutting subsystem 104 of the combined multi-vision automated cutting system 100. The cutting subsystem 104 includes the structural frame 108 and the conveyor 110 for conveying the cross section cuts 20 (FIG. 1) along the processing path A. In an embodiment, the conveyor 110 for the cutting subsystem 104 may be different than the conveyors 110 for the other subsystems 102, 106. In particular, the conveyor 100 for the cutting subsystem 104 may be a stainless-steel chain conveyor belt with narrow links to allow small objects to be processed while giving sufficient friction to avoid the material from altering its position. In other words, the spaces between the links in the conveyor 110 for the cutting subsystem 104 may be smaller than the spaces between links in the other conveyors 110 to increase contact surface area and friction with the material for processing to reduce movement of the material on the conveyor 110 during the cutting operation in the cutting subsystem 104. Such an arrangement further assists with accuracy and precision during cutting as the reduction of motion ensures that the cutting subsystem 104 is guided along the correct boundary lines through the material, as above.

The cutting subsystem 104 further includes one or more cutting assemblies 140. Each cutting assembly 140 includes a cutting head 142 coupled to or associated with a respective guide assembly 144. The guide assembly 144 may include arms 146 and links 148. The links 148 of each guide assembly 144 extend directly between a single respective cutting head 142 and at least one of the arms 146 of the respective guide assembly 144. The arms 146 may be manipulated by actuators or other like drive devices to move the links 148 and change a position of the cutting head 142. As shown in FIG. 7, there are six links 148 associated with three arms 146 (i.e., two links 148 per arm 146) in each guide assembly 144. As a result, the cutting head 142 has at least six degrees of freedom or can be moved in six different ways as a result of movement of the links 148. Alternatively, the degrees of freedom may be defined by movement of the arms 146 to generate at least 6 degrees of freedom for the cutting heard 142. Other configurations are possible.

In an embodiment, the automated cutting subsystem 104 includes multiple cutting assemblies 140 to subdivide tasks involved with cutting (i.e., each cutting assembly 140 may handle one task of the overall cutting procedure) to increase the throughput and overall yield. It may be possible to include only a single cutting assembly 140 depending on the efficiency and speed of the cutting technology in some embodiments, although multiple cutting assemblies 140 is preferred and the automated cutting system 104 may include two, three, four, or more cutting assemblies 140 arranged in series (i.e., one directly after the another). The series of cutting assemblies 140 are therefore tasked with handling a single cutting task, such as one assembly 140 for removing the skin 22 of cross section cut 20 (FIG. 1), another assembly 140 for removing the viscera 24 (FIG. 1), and so forth in any selected order of operation with respect to cutting of the cross section cut (FIG. 1).

In an embodiment, the cutting assemblies 140 may be waterjet cutting devices with the cutting heads 142 provided as waterjet cutting nozzles. Waterjet cutting is particularly advantageous for processing frozen food materials because it is hygienic and capable of processing complex geometries with an acceptable throughput rate, particularly where multiple cutting assemblies 140 are utilized. For less demanding applications with cutting of less complex geometries, alternative cutting tool devices that are cheaper and have a lower cutting precision might be more preferable to reduce complexity and cost when a high level of precision is not anticipated in the processing operation. Further, waterjet cutting devices provide a high level of flexibility, accuracy, and precision that are beneficial for particular applications of processing frozen fish and/or frozen tuna compared to other types of cutting devices.

In various embodiments, the movement speed of the robotic system, the size of the nozzle opening at the cutting heads 142, and the pressure of the waterjet cutting system (i.e., cutting assemblies 140) are optimized to maximize throughput while minimizing cutting loss. Such characteristics of the cutting assemblies 140 may also vary with the movement speed or throughput speed of the conveyor 110 of the cutting subsystem 104. Further, the characteristics of the cutting assemblies 140 may vary according to the size, type, and amount of material to be processed. In some embodiments, the waterjet for each cutting assembly 140 can be turned ON and OFF, such as with controller 112 (FIG. 3) whenever a piece of the material needs to be cut. The determination of the timing of the cutting of each cross section cut 20 (FIG. 1) and therefore the determination of when to activate and deactivate each cutting assembly 140 may be based on sensors, such as proximity sensors, associated with the cutting assemblies 140. Alternatively, such determinations can be made via the vision subsystem 102. In a non-limiting example, when cross section cuts 20 (FIG. 1) pass the cameras 118 (FIG. 4A) at a given rate, the cutting assemblies 140 can be instructed to process and/or cut the cross section cuts 20 (FIG. 1) based on the rate and order in which the cuts 20 (FIG. 1) pass the cameras 118, as further informed by the coordinates and overall guide process described herein.

During operation, and after defining the cutting path from the visual information (i.e., the boundaries converted into coordinates with a START and STOP location), an algorithm calculates the total cutting path per piece and balances the workload across the multiple robotic systems or cutting assemblies 140. The robotic system may utilizes full Rx-Ry-Rz translation capabilities to follow the material while also tracing the curves of the vision guided cutting trajectories. Angles (Rq1, Rq2, Rq3, Rq4) are formed across the longitudinal and lateral axis of the cross section cut 20 (FIG. 1), to best approximate the shape of cuts to be performed by each cutting assembly 140 or other robotic system. In this way, the cutting subsystem 104, and more specifically, the cutting assemblies 140 are guided by information from the vision subsystem 102 to automatically process materials with multiple cutting assemblies 140 utilized to increase throughput and yield.

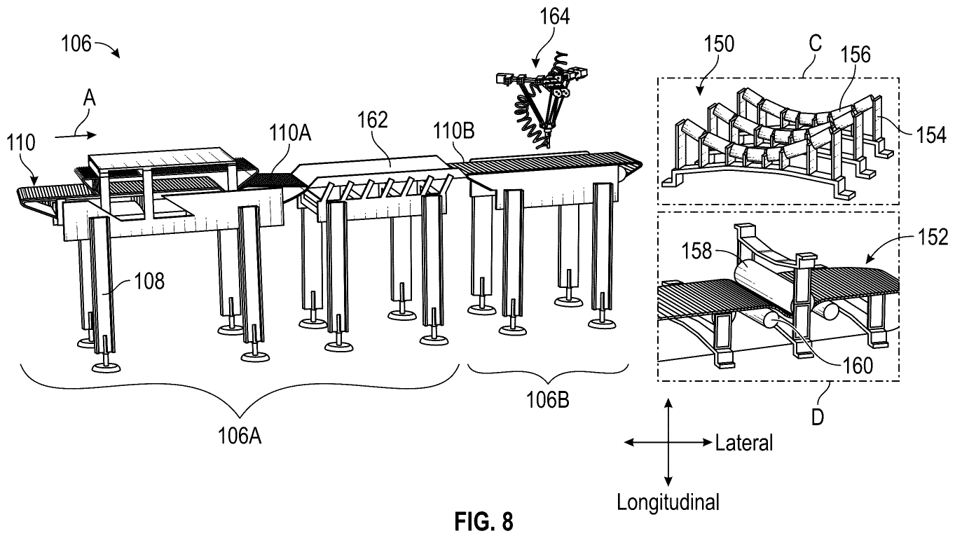

FIG. 8 illustrates the material handling and separation subsystem 106 of the combined multi-vision automated cutting system 100 in more detail. While the automated cutting subsystem 104 physically separates the different parts of the cross section cuts 20 (FIG. 1), the component parts of each cross section cut 20 after the cutting operation are still next to each other and may be in contact or close proximity with each other following the cutting operation. In the case of processing frozen products, such an arrangement can cause each separate part following cutting to freeze together. As a result, the system 100 includes the material handling and separation subsystem 106 to assist with separation of each cut component, and particular separation of main products from co-products, and selection of certain products for removal and/or further processing, as described below.

The separation and material handling subsystem includes the structural frame 108 and conveyor 110, as shown in FIG. 8. The separation and material handling subsystem 106 generally includes a separation section 106A and a material handling section 106B with each section 106A, 106B including a respective conveyor component 110A, 110B. The separation section 106A is configured to bend each cross section cut 20 (FIG. 1) along two major axes in sequence and orthogonal to each other to assist with initial separation of the cut components of each cross section cut 20 (FIG. 1). The conveyor component 110A of the separation section 106A may be a sandwich conveyor belt system that includes belts above and below, and both in contact with, the material to be processed. The conveyor component 110A includes a V-shaped or U-shaped section 150 shown in detail view C and a roller section 152 shown in detail view D to create the two different curvatures in the conveyor component 110A.

The first curvature formed by the V-shaped section 150 includes sides 154 that are elevated by angled rollers 156 carrying the belt or belts of the conveyor component 110A. The lowest point in the curve of each roller 156 is centered in the middle. Further, each curved roller 156 may have the same, or a different, radius of curvature relative to the other rollers 156 that may be constant or that may change across each roller 156. In an embodiment where the rollers 156 each have a constant radius of curvature that is the same as the other rollers 156, the rollers 156 form a curve that puts pressure across a lateral axis (i.e., left to right) of each cross section cut 20 (FIG. 1), which causes a first break in the cross section cuts 20 (FIG. 1) along the lateral axis shown in FIG. 8.

The second curvature formed by the roller section 152 includes a series of rollers laid across the belt but at different heights such that a downward facing arc is formed along the conveyor component 110A. In an embodiment, and as shown in detail view D, the series of rollers includes at least a first roller 158 and two second rollers 160 arranged at different heights relative to the structural frame 108. The first roller 158 may have a larger diameter than the second rollers 160 with the first roller 158 centered with respect to the second rollers 160 and positioned in a space between the second rollers 160 such that the second rollers 160 are positioned on, and spaced from, either side of the first roller 158. The arrangement of the rollers 158, 160 applies pressure to the cross section cuts 20 (FIG. 1) in the longitudinal direction and therefore causes further breaks between the cut components in each cross section cut 20 (FIG. 1) along the longitudinal axis. In some applications, utilizing two curvatures with different arrangements is sufficient for initially loosening each cross section cut 20 (FIG. 1) and form wider gaps between each component of the cuts 20 (FIG. 1). In particular, the lateral and longitudinal directions are orthogonal or perpendicular to each other, such that gaps are formed in both directions between the separated components of each cross section cut 20 (FIG. 1).

The separation section 106A further includes a shaker conveyor system 162 downstream of the conveyor component 110A to further increase the distance between each cut component of the cross section cuts 20 (FIG. 1). In operation, the shaker conveyor system 162 vibrates and/or has a repetitive motion to widely scatter cut components of the cross section cuts 20 (FIG. 1) while conveying the cut components along the processing path A.

The material handling section 106B is downstream of the separation section 106A and receives the scattered components from the shaker conveyor system 162. In an embodiment, the speed of the second conveyor component 110B associated with the material handling section 106B is increased relative to the speed of the first conveyor component 110A to provide further separation of the cut components of the cross section cuts 20 (FIG. 1). At this stage, the cut components of the cross section cuts 20 (FIG. 1) are sufficiently distributed for a pick and place system 164 to identify and pick up co-products from the second conveyor component 110B, thus separating the co-products from the remaining main products. In this way, the pick and place system 164 allows only the main product to transition to the next process operation. In an embodiment, the pick and place system 164 is associated with an additional vision subsystem, which may have similarities to the vision subsystem 102, but may only have one line-scan camera 118 above the conveyor component 110 in some embodiments, to assess the quality of the co-products and/or main products and identify the quantity of remaining impurities in each individual piece according to the concepts of the disclosure. If the quantity of remaining impurities exceeds a selected threshold (i.e., at least 2.5%, at least 5%, or at least 10% or more) relative to the computed cutting pattern, the pick and place system 164 rejects the product from the second conveyor component 110B and/or from further processing.

The characteristics, and the amount, of acceptable and unacceptable pieces on the second conveyor component 110B, as determined by the vision system associated with the pick and place system 164, may depend on the performance of the vision subsystem 102 and the precision of the automated cutting subsystem 104. The information collected at the separation and material handling subsystem 106 is used to directly adjust and control the parametrization of the computational methods utilized by the vision subsystem 102 in a feedback loop in some embodiments. For example, the determined characteristics by the vision system associated with the pick and place system 164 allow for calculation of an offset to the boundary extraction and cutting path procedures described above based on the difference between expected (i.e., calculated) cutting path and actual detected results at the separation and material handling subsystem 106. As a result, the concepts of the disclosure contemplate a computational method in the form of a self-regulating feedback loop to optimize the integrated subsystems within the larger overall system 100 and balance between yield loss and rejected pieces.

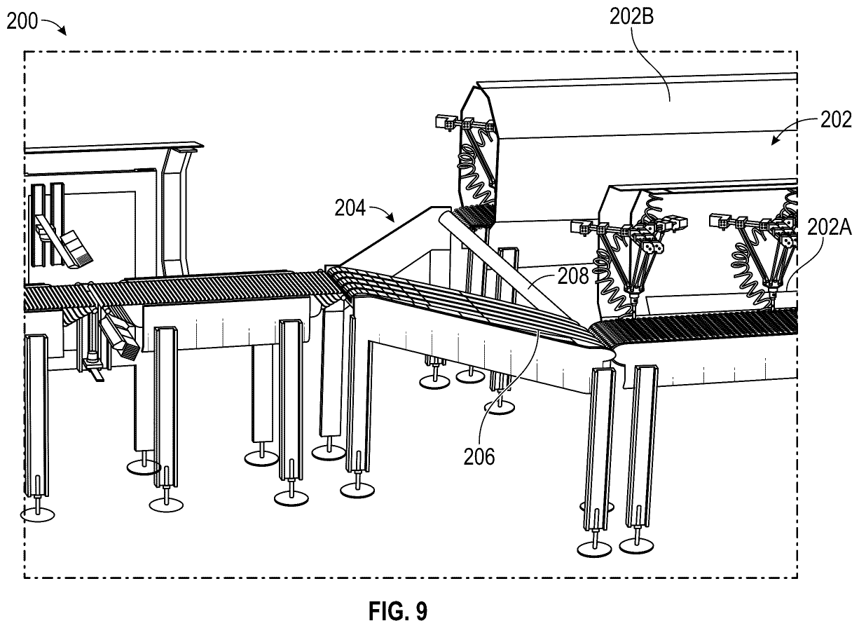

FIG. 9 illustrates an embodiment of a system 200 with an automated cutting subsystem 202 that includes divergent processing paths for parallel cutting operations. Depending on the characteristics of the overall system, and the length and complexity of the cutting path computed for each cross section cut 20 (FIG. 1), a bottleneck may occur at the automated cutting subsystem. Accordingly, the system 200 includes the automated cutting subsystem 202 with a divergence conveyor system 204 with stretchable and/or movable belt lines 206. The divergence conveyor system 204 can be provided to alternate the in-feed into automated cutting subsystems 202, including at least first cutting subsystem 202A and second cutting subsystem 202B arranged in parallel, by moving and/or sliding the belt lines 206 along a guide bar or rail 208 extending between inlets of each automated cutting subsystem 202A, 202B. Other configurations are possible, such as separate conveyors that lead into each cutting subsystem 202A, 202B and a divider plate that can be manipulated to vary the in-feed, among other possibilities. The divergence conveyor system 204 enables an increase in throughput through the automated cutting subsystem 202 without major disruption to the positioning of the objects, and as such to maintain the reference and calibration between vision subsystem and automated cutting subsystem. As a result, the system 200 contemplates a parallel processing arrangement for at least the automated cutting subsystem 202 to increase throughput without increasing the number of vision subsystems to maximize capacity utilization. The system 200 may also include more than two cutting subsystems 202A, 202B in a similar parallel arrangement, such as at least three, four, five or more cutting subsystems arranged in parallel in the automated cutting subsystem 202.

In the above description, certain specific details are set forth in order to provide a thorough understanding of various embodiments of the disclosure. However, one skilled in the art will understand that the disclosure may be practiced without these specific details. In other instances, well-known structures associated with the technology have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise.

Generally, unless otherwise indicated, the materials for making the invention and/or its components may be selected from appropriate materials such as composite materials, ceramics, plastics, metal, polymers, thermoplastics, elastomers, plastic compounds, catalysts and ammonia compounds, and the like, either alone or in any combination.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A food processing system, comprising:
a structural frame including a conveyor defining a processing path;
a vision subsystem coupled to the structural frame and arranged along the processing path, the vision subsystem including at least two cameras configured to capture images of opposite sides of a material on the conveyor and generate superimposed and extracted boundaries of main products and co-products in the material based on the images;
an automated cutting subsystem coupled to the structural frame and arranged along the processing path, the automated cutting subsystem configured to cut the material along the boundaries of the main products and the co-products in the material; and
a separation and material handling subsystem coupled to the structural frame and arranged along the processing path, the separation and material handling subsystem configured to separate the main products and the co-products and remove the co-products from the main products.

2. The food processing system of claim 1, wherein the at least two cameras are configured to capture the images of the opposite sides of the material in a plurality of different wavelengths of light to assist with generating the superimposed and extracted boundaries of the main products and co-products in the material.

3. The food processing system of claim 1, wherein the vision subsystem further includes at least one of a x-ray imaging system and an infrared camera.

4. The food processing system of claim 1, wherein the automated cutting subsystem includes at least two cutting assemblies with each cutting assembly having a cutting head provided with at least six degrees of freedom by the cutting assembly.

5. The food processing system of claim 1, wherein the separation and material handling subsystem includes a shaker conveyor system configured to vibrate configured to separate the main products and the co-products.

6. The food processing system of claim 5, wherein the separation and material handling subsystem includes a pick and place system configured to identify and remove the co-products from the main products along the processing path.

7. The food processing system of claim 6, wherein the pick and place system is associated with a vision system including at least one camera configured to capture further images of the co-products and the main products and generate further superimposed and extracted boundaries of the main products and the co-products as cut by the automated cutting subsystem,
wherein the vision system associated with the pick and place system transmits data to at least one of the vision subsystem and the automated cutting subsystem in a feedback loop to adjust the superimposed and extracted boundaries of the main products and the co-products based on the further superimposed and extracted boundaries of the main products and the co-products.

8. A food processing system, comprising:
a structural frame including a conveyor system and a processing path along the conveyor system;
a vision subsystem coupled to the structural frame and arranged along the processing path, the conveyor system including a first conveyor component and a second conveyor component associated with the vision subsystem, the first conveyor component being spaced from the second conveyor component by an air gap, the vision subsystem including at least two cameras on opposite sides of the conveyor system, wherein one camera of the at least two cameras has a field of view at least partially through the air gap between the first conveyor component and the second conveyor component to capture images of a bottom surface of a material on the conveyor system;
an automated cutting subsystem coupled to the structural frame and arranged along the processing path, the automated cutting subsystem including at least two cutting assemblies configured to cut the material along boundaries between co-products and main products based on information from the vision subsystem; and
a separation and material handling subsystem coupled to the structural frame and arranged along the processing path, the separation and material handling subsystem including a shaker conveyor system configured to separate the main products and the co-products and a pick and place system configured to identify and remove the co-products from the main products.

9. The system of claim 8, wherein the images are captured at a plurality of different wavelengths of light, including a first wavelength of light between and including 727 to 747 nm, a second wavelength of light between and including 778 to 798 nm, and a third wavelength of light between and including 1305 nm to 1325 nm.

10. The system of claim 8, wherein a nosebar of the first conveyor component and a nosebar of the second conveyor component each have a diameter less than 5 mm and the air gap is less than 10 mm in order to convey the material across the air gap from the first conveyor component to the second conveyor component in a straight line and prevent disruption of location and positioning of the material.

11. The system of claim 8, further comprising:
a plurality of air nozzles associated with one of the at least two cameras below the conveyor system, the plurality of air nozzles configured to output air to deflect debris that passes through the air gap.

12. The system of claim 8, wherein the at least two cameras are offset with respect to each other.

13. The system of claim 8, wherein the conveyor system includes a third conveyor component associated with the separation and material handling subsystem, the third conveyor component including at least one curvature to apply pressure on the material on the conveyor system along at least one of a lateral axis and a longitudinal axis through the material.

14. The system of claim 8, wherein the conveyor system includes a divergence conveyor system associated with the automated cutting subsystem and the automated cutting subsystem includes at least two cutting systems arranged in parallel.

15. A food processing method, comprising:
capturing images of opposite sides of a material at a plurality of different wavelengths of light with at least two cameras of a vision subsystem;
generating, based on the images, superimposed and extracted boundaries of main products and co-products in the material;
cutting the material along the boundaries of the main products and the co-products with one or more cutting assemblies of an automated cutting subassembly;
separating the main products from the co-products, including passing the main products and co-products through at least one curvature of a conveyor and picking the co-products from the main products on the conveyor with a pick and place system.

16. The method of claim 15, wherein capturing images of opposite sides of the material includes arranging the at least two cameras on opposite sides of the conveyor with a field of view of one camera of the at least two cameras at least partially passing through an air gap between sections of the conveyor.

17. The method of claim 15, wherein the plurality of different wavelengths include a first wavelength of approximately 737 nm, a second wavelength of approximately 788 nm, and a third wavelength of approximately 1315 nm.

18. The method of claim 15 wherein passing the main products and the co-products through at least one curvature of the conveyor includes passing the main products and the co-products through at least two curvatures of the conveyor and applying pressure along a lateral axis and a longitudinal axis orthogonal to the lateral axis.

19. The method of claim 15, wherein separating the main products from the co-products further includes vibrating the main products and the co-products with a shaker conveyor system of the conveyor.

20. The method of claim 15, wherein generating the superimposed and extracted boundaries of main products and co-products in the material includes superimposing images of the opposite sides of the material and identifying boundaries based on differences in light intensity of the main products and co-products at a plurality of peak contrasts associated with the plurality of different wavelengths of light, and extrapolating boundaries through the material based on the identified boundaries on the opposite sides of the material.
